(19) United States
(12) Patent Application Publication
(10) Pub. No.: US 2023/0378431 A1
(43) Pub. Date: Nov. 23, 2023

(54) ALL-SOLID-STATE SECONDARY BATTERY

(71) Applicant: SAMSUNG SDI CO., LTD., Yongin-si, Gyeonggi-do (KR)

(72) Inventor: Taeri KWON, Yongin-si, Gyeonggi-do (KR)

(21) Appl. No.: 18/013,115

(22) PCT Filed: Nov. 12, 2021
(86) PCT No.: PCT/KR2021/016565

§ 371 Date: Jul. 14, 2023

(30) Foreign Application Priority Data
Nov. 17, 2020 (KR) 10-2020-0153771

(51) Int. Cl. H01M 4/131; H01M 10/0525; H01M 10/0562; H01M 4/62; H01M 4/66

(52) U.S. Cl. CPC H01M 4/131; H01M 10/0525; H01M 10/0562; H01M 4/623; H01M 4/661; H01M 2004/028

(57) ABSTRACT

Provided is an all-solid-state secondary battery including: a positive electrode layer; a negative electrode layer; and a solid electrolyte layer arranged between the positive electrode layer and the negative electrode layer. The positive electrode layer includes a positive current collector and a positive active material layer arranged on the positive current collector, the positive active material layer includes a first positive active material layer arranged on the center of the positive current collector and a second positive active material layer surrounding the first positive active material layer and arranged on the periphery of the positive current collector, the negative electrode layer includes a negative current collector and a first negative active material layer or a third negative active material layer arranged on the negative current collector.

### TECHNICAL FIELD

The present invention relates to an all-solid-state secondary battery.

### BACKGROUND ART

Recently, the development of batteries with high energy density and safety has been actively carried out in response to industrial demands. For example, lithium-ion batteries are being put to practical use not only in the fields of information-related devices and communication devices, but also in the fields of automobiles. In the fields of automobiles, safety is especially considered important as being related to life.

Lithium-ion batteries currently available on the market use a liquid electrolyte containing a flammable organic solvent, and thus overheating and fire may occur in the case of a short circuit. In this regard, all-solid batteries using a solid electrolyte instead of an electrolytic solution is being proposed.

All-solid batteries do not use a flammable organic solvent, and thus the possibility of fire or explosion may be greatly reduced even in the case of a short circuit. Therefore, such all-solid batteries may have significantly increased stability compared to lithium-ion batteries using an electrolytic solution.

### DISCLOSURE

### Technical Problem

One aspect provides an all-solid-state secondary battery including a positive electrode including a large-diameter positive active material and a small-diameter positive active material, the positive active materials including cracks radially arranged therein.

### Technical Solution

According an aspect, an all-solid-state secondary battery includes:
a positive current collector; and a positive active material layer arranged on the positive current collector,
wherein the positive active material layer includes: a first positive active material; a second positive active material; and a solid electrolyte,
the first positive active material is a large-diameter positive active material, and the second positive active material is a small-diameter positive active material,
the first positive active material includes a secondary particle having a plurality of primary particles, and one or more cracks are radially arranged inside the secondary particle.

According to another aspect, an all-solid-state secondary battery includes:
a positive electrode; a negative electrode; and a solid electrolyte layer,
wherein the negative electrode includes: a negative current collector; and a first negative active material layer arranged on the negative current collector.

### Advantageous Effects

According to one aspect, the all-solid-state secondary battery including the positive electrode may have improved energy density and improved cycle characteristics.

### DESCRIPTION OF DRAWINGS

FIG. 1 is a cross-sectional view of a positive active material particle including cracks radially arranged therein according to an embodiment.

FIG. 2 is a cross-sectional view of a positive active material particle including cracks arranged therein without orientation.

FIG. 3 is a cross-sectional view of a positive active material layer including a large-diameter positive active material and a small-diameter positive active material according to an embodiment.

FIG. 4 is a cross-sectional scanning electron microscope (SEM) image of a positive active material layer prepared according to Example 1.

FIG. 5 is a cross-sectional SEM image of a positive active material layer prepared according to Comparative Example 1.

FIG. 6 is a cross-sectional SEM image of a positive active material layer prepared according to Comparative Example 2.

FIG. 7 is a cross-sectional view of an all-solid-state secondary battery according to an embodiment.

### BEST MODE

Due to generation of cracks not having orientation in a positive active material particle during a charging and discharging process of a secondary battery including a liquid electrolyte, the liquid electrolyte penetrates into the positive active material so that occurrence of side reactions increases. Consequently, cycle characteristics of the secondary battery including the liquid electrolyte may be degraded. Meanwhile, due to generation of cracks not having orientation in a positive active material particle during a charging and discharging process of a secondary battery including a solid electrolyte, a portion that is electrically and/or ionically disconnected from the solid electrolyte and/or a conductive material inside the positive active material increases. Consequently, cycle characteristics of the secondary battery including the solid electrolyte may be degraded. Thus, to suppress the cracking of the positive active material in the secondary battery including the solid electrolyte, a small-diameter positive active material having an average particle diameter of less than 10 um is mainly used. Accordingly, a positive electrode including a small-diameter positive active material as a positive active material has a low mixture density. Thus, an all-solid-state secondary battery including such a positive electrode may have a lowered energy density.

A positive electrode according to one aspect may include: a large-diameter positive active material including cracks radially arranged therein; and a small-diameter positive active material, and an all-solid-state secondary battery including the positive electrode may have improved energy density and improved cycle characteristics.

The present inventive concept described hereinbelow may have various modifications and various embodiments, example embodiments will be illustrated in the drawings and more fully described. The present inventive concept may, however, should not be construed as limited to the example embodiments set forth herein, and rather, should be understood as covering all modifications, equivalents, or alternatives falling within the scope of the present inventive concept.

The terms used herein is for the purpose of describing particular embodiments only, and is not intended to be limiting the present inventive concept. An expression used in the singular encompasses the expression of the plural, unless it has a clearly different meaning in the context. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. As used herein, “/” may be interpreted as “and”, or as “or” depending on the context.

In the drawings, thicknesses may be magnified or exaggerated to clearly illustrate various layers and regions. Like reference numbers may refer to like elements throughout the drawings and the following description. It will be understood that when one element, layer, film, section, sheet, etc. is referred to as being “on” another element, it can be directly on the other element or intervening elements may be present therebetween. Although the terms “first,” “second,” etc. may be used herein to describe various elements, these elements should not be limited by these terms. These terms are only used to distinguish one element from another element. In the present specification and drawings, components having substantially the same functional features are referred to the same reference numerals, and thus repeated descriptions will be omitted.

In the present specification, the term “particulate structure” refers to a particulate structure formed by aggregating a plurality of primary particles. In the present specification, the secondary particle may include, for example, at least one or at least two radial centers.

In the present specification, the “central part” of the secondary particle of the positive active material refers to a region within 40% to 60% by length, for example, 50% by length, from the center, of based on a total distance between the center of the secondary particle of the positive active material and the outermost periphery, or to a remaining region except for a region within 2 μm from the surface of the secondary particle of the positive active material. The center of the secondary particle of the positive active material is, for example, the geometrical center of the secondary particle of the positive active material.

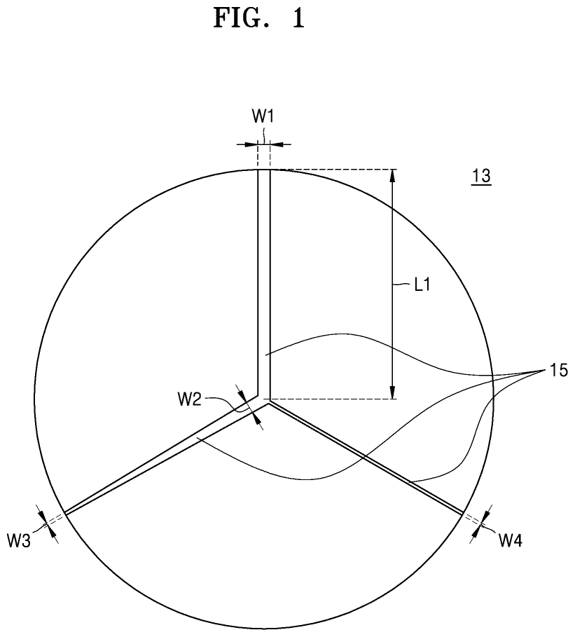

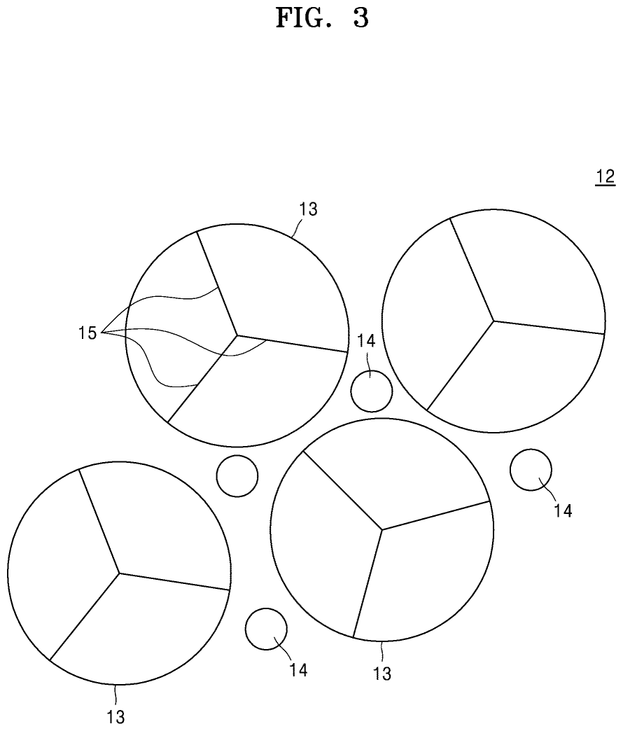

In the present specification, “radial type” refers to, as shown in FIGS. 1 and 3, a shape in which cracks arranged in a particle are arranged in a direction perpendicular to the surface of the particle, or arranged to form a direction of ±30° with the direction perpendicular to the surface of the particle. For example, the radially arranged cracks are arranged in a direction perpendicular to the surface of the secondary particle from the center of the secondary particle, or arranged to form in a direction of ±30° with the direction perpendicular to the surface of the secondary particle. For example, a plurality of cracks are radially arranged.

In the present specification, the term “radial center” refers to the center of a particulate structure including a plurality of cracks radially arranged in the particle as shown in FIGS. 1 and 3.

In the present specification, the term “particle diameter” of particles refers to an average diameter of particles when the particles are spherical, and refers to an average major axis length of particles when the particles are non-spherical. The particle diameter of the particles may be measured by using a particle size analyzer (PSA). The “particle diameter’ of the particles refers to, for example, an average particle diameter. The average particle diameter may be, for example, a median particle diameter (D50). The median particle diameter D50 is a particle size corresponding to a 50% cumulative volume calculated from particles having a small particle size in a particle size distribution measured by, for example, a laser diffraction method.

Hereinafter, a positive electrode according to embodiments and an all-solid-state secondary battery including the same will be described in more detail.

[Positive Electrode]

[Positive Electrode Layer: Positive Active Material]

Referring to FIGS. 1, 3, 4, and 7, a positive electrode 10 includes a positive current collector 11 and a positive active material layer 12 arranged on the positive current collector 11. The positive active material layer 12 may include, for example, a first positive active material 13, a second positive active material 14, and a solid electrolyte. The first positive active material 13 may be a large-diameter positive active material, and the second positive active material 14 may be a small-diameter positive active material.

Referring to FIGS. 1, 3, 4, and 7, the first positive active material 13 may include a secondary particle including a plurality of primary particles, and the secondary particle may include at least one crack 15 radially arranged therein. When the secondary particle of the first positive active material 13 includes at least one crack 15 radially arranged therein, due to the at least one crack 15 inside the secondary particle of the first positive active material 13, the formation of a region separated ionically and/or electrically from the positive active material layer may be suppressed. Therefore, an all-solid-state secondary battery 1 including the positive electrode 10 including the first positive active material 13 may have improved cycle characteristics.

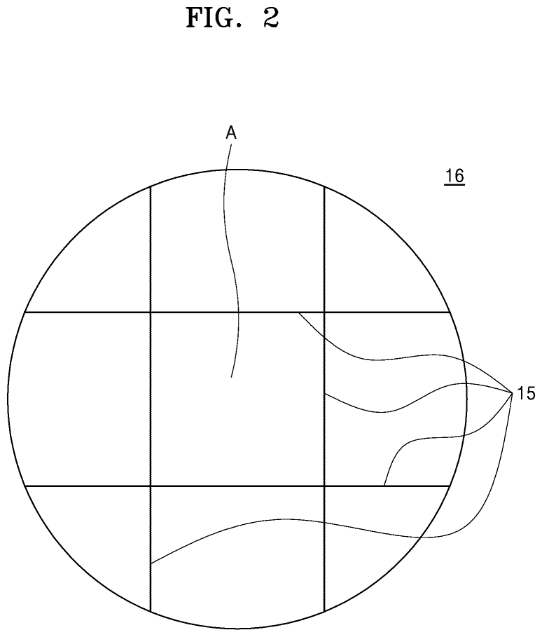

Referring to FIGS. 2, 5, and 7, a positive active material 16 of the related art may include, for example, a plurality of cracks 15 that are arranged without orientation inside a secondary particle. When the secondary particle of the positive active material 16 includes a plurality of cracks 15 arranged without orientation therein, due to the plurality of cracks 15 inside the secondary particle of the positive active material 16, the formation of a region separated ionically and/or electrically from the positive active material layer 12 may increase. Therefore, an all-solid-state secondary battery 1 including the positive electrode 10 including the positive active material 16 may have degraded cycle characteristics. For example, a region indicated by A in FIG. 2 is separated ionically and/or electrically from the positive active material layer.

Referring to FIG. 1, a ratio of the width W1, W2, W3, or W4 to the length L1 of the crack included in the secondary particle of the first positive active material 13 may be, for example, in a range of 1:10 to 1:1000, 1:10 to 1:500, 1:10 to 1:400, 1:10 to 1:300, 1:10 to 1:200, or 1:10 to 1:100.

The width W1, W2, W3, or W4 of the crack may be, for example, 200 nm or less, 100 nm or less than, 50 nm or less, 30 nm or less, 20 nm or less, 10 nm or less, or 5 nm or less. The width W1, W2, W3, or W4 of the crack may be, for example, in a range of 0.1 nm to 200 nm, 0.5 nm to 100 nm, 1 nm to 50 nm, 1 nm to 30 nm, 1 nm to 20 nm, 1 nm to 10 nm, or 1 nm to 5 nm. The length L1 of the crack may be, for example, 30% or more, 40% or more, or 50% or more of the diameter of the secondary particle. The length L1 of the crack may be, for example, at least in a range of 30% to 100%, 30% to 90%, or 30% to 80% of the diameter of the secondary particle. The crack included in the secondary particle may extend to, for example, the surface of the secondary particle. Thus, the crack is exposed on the surface of the secondary particle. For example, the width W2 of the crack inside the secondary particle may be greater than or equal to the width W3 of the crack on the surface of the secondary particle. For example, a plurality of the cracks radially arranged are connected to each other inside the secondary particle, for example, at the center of the secondary particle. At the cracks arranged inside the secondary particle, the solid electrolyte is not substantially present. Thus, despite the cracks, the secondary particle does not cause additional side reaction with the solid electrolyte while maintaining the ionic connectivity between the secondary particle and the solid electrolyte.

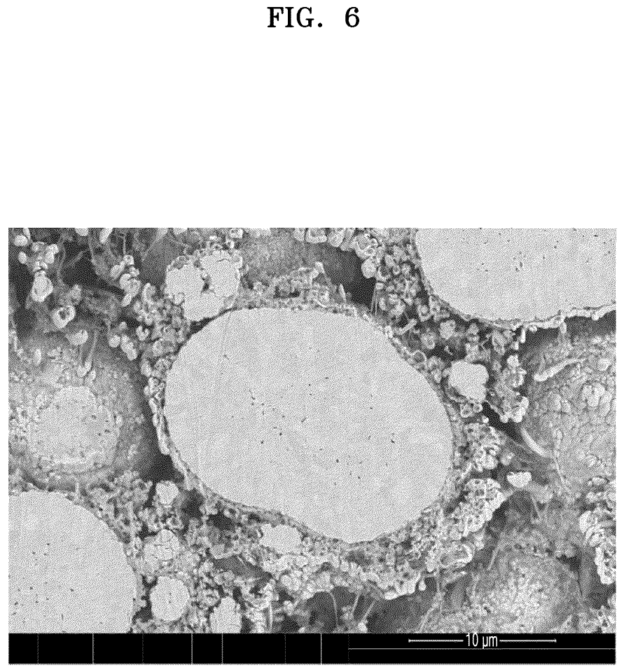

The crack included in the secondary particle of the first positive active material are distinguished from grain boundary or pores formed among a plurality of the primary particles. For example, in FIG. 6, grain boundary or pores arranged among a plurality of the primary particles included in the secondary particle are not the aforementioned cracks.

Referring to FIGS. 1 and 3, the particle diameter of the first positive active material 13 may be, for example, in a range of 11 um to 30 um, 11 um to 25 um, 14 um to 24 um, 14 um to 22 um, 14 um to 20 um, 16 um to 20 um, or 17 um to 19 um. When the particle diameter of the first positive active material 13 is within the ranges above, the mixture density of the positive active material layer 13 may be further improved. The particle diameter of the second positive active material 14 may be, for example, in a range of 1 um to 9 um, 1 um to 6 um, 1 um to 5 um, 2 um to 5 um, or 2 um to 4 um. When the particle diameter of the second positive active material 13 is within the ranges above, the second positive active material may be arranged on a space among the first positive active material 13 more effectively. The difference in the particle diameters of the first positive active material 13 and the second positive active material 14 may be, for example, 5 um or more, 10 um or more, 12 um or more, or 14 um or more. The difference in the particle diameter of the first positive active material 13 and the second positive active material 14 may be, for example, in a range of 5 um to 19 um, 7 um to 19 um, 10 um to 19 um, 12 um to 18 um, or 14 um to 16 um. When the first positive active material 13 and the second positive active material 14 have such a difference in the particle diameters within the ranges above, the mixture density of the positive active material layer 12 may be further improved. The particle diameter of each of the first positive active material 13 and the second positive active material 14 may be, for example a median particle diameter (D50). The weight ratio of the first positive active material 13 and the second positive active material 14 may be, for example, in a range of 90:10 to 60:40, 90:10 to 70:30, or 85:15 to 75:25. When the first positive active material 13 and the second positive active material 14 are mixed at the weight ratio within the ranges above, for example, the mixture density of the positive active material layer 12 may be further improved.

The particles of the first positive active material 13 and/or the particles of the second positive active material 14 may have, for example, a circular, elliptical, or spherical shape, but the shape is not necessarily limited thereto. Any particle shape may be used. The amount of the first positive active material 13 and/or the second positive active material 14 included in the positive active material layer 12 is not particularly limited, and may be within a range applicable to the positive active material layer 12 of the all-solid-state secondary battery 1.

The first positive active material and/or the second positive active material may include a lithium transition metal oxide. The first positive active material and/or the second positive active material may be, for example, a lithium transition metal oxide capable of absorbing and desorbing lithium ions irreversibly.

The lithium transition metal oxide used as the first positive active material and/or the second positive active material may be, for example, a compound represented by one of the following formulae: LiₐA_{1-b}B_{b}D₂ (where 0.90≤a≤1 and 0≤b≤0.5); LiₐE_{1-b}B_{b}O_{2-c}D_{c} (where 0.90≤a≤1, 0≤b≤0.5, 0 and ≤c≤0.05); LiₐNi_{1-b-c}Co_{b}B_{c}D_{α} (where 0.90≤a≤1, 0≤b≤0.5, 0≤c≤0.05, and 0<α≤2); LiₐNi_{1-b-c}Co_{b}B_{c}O_{2-α}F_{α} (where 0.90≤a≤1, 0≤b≤0.5, 0≤c≤0.05, and 0<α≤2); LiₐNi_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b≤0.5, 0≤c≤0.05, and 0<α≤2); LiₐNi_{1-b-c}Mn_{b}B_{c}O_{2-α}F_{α} (where 0.90≤a≤1, 0≤b≤0.5, 0≤c≤0.05, and 0<α<2); LiₐNi_{1-b-c}Mn_{b}B_{c}O_{2-α}F₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1); LiₐNi_{b}Co_{c}Mn_{d}GeO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1 and 0.001≤b≤0.1); LiₐCoG_{b}O₂ (where 0.90≤a≤1 and 0.001≤b≤0.1); and LiₐMnG_{b}O₂ (where 0.90≤a≤1 and 0.001≤b≤0.1).

In the compound represented by one of the formulae above, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof. A compound having a coating layer may be also added to the surface of the aforementioned compound, and a mixture of the aforementioned compound and a compound having a coating layer may be also used. Such a coating layer added to the surface of the compound described above may include, for example, a coating element compound such as an oxide of a coating element, hydroxide of a coating element, oxyhydroxide of a coating element, oxycarbonate of a coating element, or hydroxy carbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. A method of forming the coating layer may be selected within a range that does not adversely affect the physical properties of the positive active material. The coating method may be, for example, spray coating, dipping method, or the like. A detailed description of the coating method will be omitted because it may be well understood by those in the art.

The first positive active material and/or the second positive active material may include, for example, a lithium salt of the transition metal oxide having a layered rock salt type structure among the aforementioned lithium transition metal oxide. The term “layered rock salt type structure” as used herein refers to, for example, a structure in which oxygen atomic layers and metal layers are alternately arranged regularly in the [111] direction of a cubic rock salt type structure to form a two-dimensional plane by each of the atomic layers. The term “cubic rock salt type structure” as used herein refers to a NaCl type structure which is one type of crystal structures, and in detail, refers to a structure in which a face centered cubic lattice (fcc) formed by respective anions and cations is misaligned from each other by ½ of the ridge of a unit lattice. The lithium transition metal oxide having such a layered rock salt type structure may be a ternary compound, such as LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the first positive active material and/or the second positive active material includes a ternary lithium transition metal oxide having a layered rock salt type structure, the energy density and thermal stability of the all-solid-state secondary battery 1 may be further improved. When the first positive active material and/or the second positive active material includes, for example, nickel (Ni) as a ternary lithium transition metal oxide such as NCA or NCM, the capacity density of the all-solid-state secondary battery 1 increases so that the metal elution rate of the positive active material may be reduced in a charged state. Consequently, the cycle characteristics of the all-solid-state secondary battery 1 may be improved. The first positive active material and/or the second positive active material may be, for example, a lithium transition metal oxide, such as lithium cobalt oxide (LCO), lithium nickel oxide, lithium nickel cobalt oxide, lithium nickel cobalt aluminum oxide (NCA), lithium nickel cobalt manganese oxide (NCM), and the like.

The first positive active material and/or the second positive active material may include, for example, a nickel-based first lithium transition metal oxide represented by Formula 1:

LiₐNi_{b}M1_{c}M2_{d}M3_{c}O_{2-α}X_{α} Formula 1
wherein, in the formulae above,
0.9≤a≤1.1, 0.7<b<1.0, 0<c<0.3, 0<d<0.3, 0≤e<0.1, b+c+d+e=1, and 0≤α<2,
M1, M2, and M3 are each one selected from cobalt (Co), manganese (Mn), zirconium (Zr), aluminum (Al), rhenium (Re), vanadium (V), chrome (Cr), iron (Fe), boron (B), ruthenium (Ru), titanium (Ti), niobium (Nb), molybdenum (Mo), magnesium (Mg), and platinum (Pt), and
X is an element selected from the group consisting of oxygen (O), fluorine (F), sulfur (S), and phosphorus (P).

The first positive active material and/or the second positive active material may include, for example, a nickel-based first lithium transition metal oxide represented by Formula 2 or 3:

LiₐNi_{b}Co_{c}Mn_{d}M4ₑO_{2-α}X_{α} Formula 2

LiₐNi_{b}Co_{c}Al_{d}M4ₑO_{2-α}X_{α} Formula 3
wherein, in the formulae above,
0.9≤a≤1.1, 0.8<b<1.0, 0<c<0.2, 0<d<0.1, 0≤e<0.01, b+c+d+e=1, and 0≤α<2,
M4 is one selected from Zr, Al, V, Cr, Fe, Re, B, Ru, Ti, Nb, Mo, Mg, and Pt, and
X is an element selected from the group consisting of oxygen (O), fluorine (F), sulfur (S), and phosphorus (P).

The first positive active material and/or the second positive active material may include, for example, a core and a first coating layer arranged on the core, wherein the core includes a nickel-based first lithium transition metal oxide, and the first coating layer includes an oxide ionic conductor. The oxide ionic conductor may be a metal oxide having lithium ionic conductivity. The oxide ionic conductor included in the first coating layer may be, for example, Li₂O—ZrO₂ (LZO). The first coating layer may coat a part or all of the core. The first coating layer may be continuously or discontinuously arranged on the core. When the first positive active material and/or the second positive active material includes the core and the first coating layer arranged on the core and including the oxide ionic conductor, a side reaction between the solid electrolyte and the nickel-based first lithium transition metal oxide included in the core may be suppressed at a high voltage. Therefore, the cycle characteristics of the all-solid-state secondary battery including the positive electrode including the first positive active material and/or the second positive active material may be improved. The amount of the first coating layer may be, based on the total moles of the first positive active material and/or the second positive active material, in a range of 0.1 mol % to 5 mol %, 0.1 mol % to 4 mol %, 0.1 mol % to 3 mol %, 0.1 mol % to 2 mol %, 0.1 mol % to 1 mol %, or 0.2 mol % to 0.8 mol %. When the amount of the first coating layer is within the range above, the cycle characteristics of the all-solid-state secondary battery including the positive electrode including the first positive active material and/or the second positive active material may be further improved.

The first positive active material and/or the second positive active material may, for example, further include a second coating layer arranged between the core and the first coating layer. That is, the first positive active material and/or the second positive active material may include the core, the first coating layer arranged on the core, and the second coating layer arranged on the first coating layer. In addition, the core may include the nickel-based first lithium transition metal oxide, the first coating layer may include the oxide ionic conductor, and the second coating layer may include a nickel-based second lithium transition metal oxide having a greater Co amount than the nickel-based first lithium transition metal oxide included in the core. The amount of the second coating layer may be, based on the total moles of the first positive active material and/or the second positive active material, in a range of 0.1 wt % to 5 wt %, 0.1 wt % to 4 wt %, 0.1 wt % to 3 wt %, 0.1 wt % to 2 wt %, 0.1 wt % to 1 wt %, or 0.1 wt % to 0.5 wt %. When the amount of the second coating layer is within the range above, the cycle characteristics of the all-solid-state secondary battery including the positive electrode including the first positive active material and/or the second positive active material may be further improved.

The nickel-based second lithium transition metal oxide included in the second coating layer may be, for example, represented by Formula 4 or 5:

LiₐNiₚCo_{q}MnᵣM5ₛO_{2-α}X_{α} Formula 4

LiₐNiₚCo_{q}AlᵣM5ₛO_{2-α}X_{α} Formula 5
wherein, in the formulae above,
0.9≤a≤1.1, 0.4≤p≤08, 0.3≤q≤0.6, 0<r<0.05, 0≤s<0.01, p+q+r+s=1, and 0≤α<2,
M4 may be one selected from Zr, Al, V, Cr, Fe, Re, B, Ru, Ti, Nb, Mo, Mg, and Pt, and
X may be an element selected from the group consisting of oxygen (O), fluorine (F), sulfur (S), and phosphorus (P).

When the second coating layer includes the nickel-based second lithium transition metal oxide having a greater Co amount than the nickel-based first lithium transition metal oxide, the structural stability of the first positive active material and/or the second positive active material may be improved, and a side reaction between the solid electrolyte and these nickel-based lithium transition metal oxides may be suppressed more effectively. Therefore, the cycle characteristics of the all-solid-state secondary battery including the positive electrode including the first positive active material and/or the second positive active material may be improved. The second coating layer may coat a part or all of the first coating layer. The second coating layer may be continuously or discontinuously arranged on the first coating layer. In addition, the second coating layer may coat a part or all of the core. In addition, the second coating layer may be continuously or discontinuously arranged on the core.

[Positive Electrode Layer: Solid Electrolyte]

The positive active material layer 12 may include a solid electrolyte. The solid electrolyte included in the positive active material layer 12 may be identical to or different from a solid electrolyte included in the solid electrolyte layer 30. The solid electrolyte included in the positive active material layer 12 may be in contact with the first positive active material and the second positive active material, and by coating the same, may conduct lithium ions thereto.

The solid electrolyte included in the positive active material layer 12 may be, for example, a sulfur-based solid electrolyte. The sulfide-based solid electrolyte may include, for example, at least one selected from Li₂S—P₂S₅, Li₂S—P₂S₅—LiX (where X is Cl, Br, F, or I), Li₂S—P₂S₅—LiX—LiCl—LiBr, Li₂S—P₂S₅—Li₂O, Li₂S—P₂S₅—Li₂O—LiI, Li₂S—SiS₂, Li₂—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where 1≤m≤5, 1≤n≤5, and Z is Ge, Zn, or Ga), Li₂S—GeS₂, Li₂S—SiS₂—Li₃PO₄, Li₂S—SiS₂—LiₚMO_{q} (where 1≤p≤2, 1≤q≤4, and M is P, Si, Ge, B, Al, Ga, or In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). The sulfide-based solid electrolyte may be, for example, prepared by treating a starting material, such as Li₂S, P₂S₅, and the like, by a melting quenching method, a mechanical milling method, or the like. Also, after such treatment, heat treatment may be performed thereon. The solid electrolyte may be amorphous or crystalline, or may be in a mixed state. In addition, the solid electrolyte may include, for example, sulfur (S), phosphorus (P), and lithium (Li), as at least a constituent element among the aforementioned sulfide-based solid electrolyte material. For example, the solid electrolyte may be a material including Li₂S—P₂S₅. When Li₂S—P₂S₅ is included as the sulfide-based solid electrolyte material for forming the solid electrolyte, a mixing molar ratio of Li₂S to P₂S₅ (Li₂S:P₂S₅) may be, for example, in a range of 50:50 to 90:10.

The sulfide-based solid electrolyte may include, for example, an argyrodite-type solid electrolyte represented by Formula 6:

Li⁺₁₂₋ₙ₋ₓAⁿ⁺X²⁻₆₋ₓY⁻ₓ Formula 6
wherein, in the formula above, A may be P, As, Ge, Ga, Sb, Si, Sn, Al, In, Ti, V, Nb, or Ta, X may be S, Se, or Te, Y may be Cl, Br, I, F, CN, OCN, SCN, or N₃, 1≤n≤5, and 0≤x≤2. The sulfide-based solid electrolyte may be, for example, an argyrodite-type compound including at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). The sulfide-based solid electrolyte may be, for example, an argyrodite-type compound including at least one selected from Li₆PS₅Cl, Li₆PS₅Br, and Li₆PS₅I. The density of the argyrodite-type solid electrolyte may be in a range of 1.5 g/cc to 2.0 g/cc. When the density of the argyrodite-type solid electrolyte is 1.5 g/cc or more, the internal resistance of the all-solid-state secondary battery is reduced, and accordingly, the penetration of Li into the solid electrolyte layer may be suppressed effectively.

The elastic modulus, i.e., Young's modulus, of the sulfide-based solid electrolyte may be, for example, 35 GPa or less, 30 GPa or less, 27 GPa or less, 25 GPa or less, or 23 GPa or less. The elastic modulus, i.e., Young's modulus, of the sulfide-based solid electrolyte may be, for example, in a range of 10 GPa to 35 GPa, 10 GPa to 30 GPa, 10 GPa to 27 GPa, 10 GPa to 25 GPa, or 10 GPa to 23 GPa. When the elastic modulus of the sulfide-based solid electrolyte is within the ranges above, the temperature and/or pressure required for sintering is reduced, and thus sintering of the solid electrolyte may be performed more easily.

The solid electrolyte included in the positive active material layer 12 may have a smaller average particle diameter (D50) than the solid electrolyte included in the solid electrolyte layer 30. The average particle diameter D50 of the solid electrolyte included in the positive active material layer 12 may be, for example, 90% or less, 80% or less, 70% or less, 60% or less, 50% or less, 40% or less, 30% or less, or 20% or less, of the particle diameter D50 of the solid electrolyte included in the solid electrolyte layer 30. The average particle diameter D50 of the solid electrolyte included in the positive active material layer 12 may be, for example, 10% to 90%, 10% to 80%, 10% to 70%, 10% to 60%, 10% to 50%, 10% to 40%, 10% to 30%, or 10% to 20%, of the particle diameter D50 of the solid electrolyte included in the solid electrolyte layer 30.

The amount of the solid electrolyte included in the positive active material layer 12 may be, for example, 1 wt % to 50 wt %, 2 wt % to 40 wt %, 5 wt % to 30 wt %, 5 wt % to 20 wt %, or 5 wt % to 15 wt %, of the total weight of the positive active material layer 12.

[Positive Electrode Layer: Conductive Material]

The positive active material layer 12 may include a conductive material. The conductive material may be, for example, a fibrous conductive material and/or a particulate conductive material. The conductive material may be a carbon-based conductive material and/or a metal-based conductive material. The conductive material may be, for example, graphite, carbon black, acetylene black, Ketjen black, carbon nanofiber (CNF), carbon nanotube (CNT), metal powder, metal fiber, and the like. The conductive material may be a mixture of a fibrous conductive material and a particulate conductive material. The mixing ratio of the fibrous conductive material and the particulate conductive material in the mixture may be 1:9 to 9:1, 2:8 to 8:2, 3:7 to 7:3, or 4:6 to 6:4. The amount of the conductive material included in the positive active material layer 12 may be, for example, 0.1 wt % to 10 wt %, 0.2 wt % to 5 wt %, 0.3 wt % to 3 wt %, 0.5 wt % to 2 wt %, or 0.5 wt % to 1.5 wt %, of the total weight of the positive active material layer 12.

[Positive Electrode Layer: Binder]

The positive active material layer 12 may include a binder. The binder may be, for example a fluorine-based binder. The binder may include, for example, styrene butadiene rubber (SBR), polytetrafluoroethylene (PTFE), polyvinylidene fluoride (PVDF), polyethylene, and the like. The amount of the binder included in the positive active material layer 12 may be, for example, 0.1 wt % to 10 wt %, 0.2 wt % to 5 wt %, 0.3 wt % to 3 wt %, 0.5 wt % to 2 wt %, or 0.5 wt % to 1.5 wt %, of the total weight of the positive active material layer 12.

[Positive Electrode Layer: Other Additives]

The positive active material layer 12 may further include, for example, an additive such as a filler, a coating agent, a dispersant, an ion conductive auxiliary agent, and the like, in addition to the positive active material, the solid electrolyte, the binder, and the positive active material described above.

For use as the filler, the coating agent, the dispersant, the ion conductive auxiliary agent, and the like that may be included in the positive active material layer 12, a known material generally used for an electrode of an all-solid battery may be used.

[Positive Electrode Layer: Positive Current Collector]

The positive current collector 11 may be, for example, in the form of a plate or a foil, each consisting of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The positive current collector 11 may be omitted. The thickness of the positive current collector 11 may be, for example, in a range of 5 um to 100 um, 5 um to 50 um, 5 um to 40 um, 5 um to 30 um, or 10 um to 20 um.

The positive current collector 11 may further include a carbon layer arranged on one or both surfaces of a metal substrate. When the carbon layer is additionally arranged on the metal substrate, a metal of the metal substrate may be prevented from being corroded by a solid electrolyte included in the positive electrode layer 10, and the interfacial resistance between the positive active material layer 12 and the positive current collector 11 may be reduced. The thickness of the carbon layer may be, for example, in a range of about 1 μm to about 5 μm. When the carbon layer is too thin, the contact between the metal substrate and the solid electrolyte may not be completely blocked. When the carbon layer is too thick, the energy density of an all-solid battery may be reduced. The carbon layer may include amorphous carbon, crystalline carbon, or the like.

[All-Solid-State Secondary Battery]

An all-solid-state secondary battery according to an embodiment may include: the positive electrode; a negative electrode; a solid electrolyte layer arranged between the positive electrode and the negative electrode. When the all-solid-state secondary battery includes the aforementioned positive electrode, the energy density may be improved, and accordingly, the cycle characteristics may be also improved.

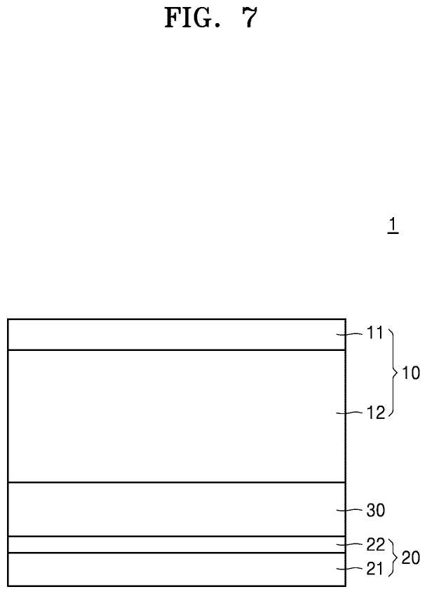

Referring to FIG. 7, the all-solid-state secondary battery 1 includes: the positive electrode 10; a negative electrode 20; and a solid electrolyte layer 30 arranged between the positive electrode 10 and the negative electrode 20, wherein the negative electrode includes a negative current collector 21 and a first negative active material layer 22 arranged on the negative current collector 21.

[Solid Electrolyte Layer]

[Solid Electrolyte Layer: Solid Electrolyte]

Referring to FIG. 7, the solid electrolyte layer 30 may include a solid electrolyte arranged between the positive electrode 10 and the negative electrode 20. The solid electrolyte included in the solid electrolyte layer 30 may have the same composition as the solid electrolyte included in the positive electrode 10.

For details on the solid electrolyte included in the solid electrolyte layer 30, the solid electrolyte included in the positive electrode 10 may be referred.

[Solid Electrolyte Layer: Binder]

The solid electrolyte layer 30 may further include, for example, a binder. The binder included in the solid electrolyte layer 30 may include, for example, SBR, PTFE, PVDF, polyethylene, or the like, but is not limited thereto. Any material available as a binder in the art may be used. The binder included in the solid electrolyte layer 30 may be identical to the binder included in the positive active material layer 12 and/or the negative active material layer 22.

The amount of the binder included in the solid electrolyte layer 30 may be, for example, 0.1 wt % to 10 wt %, 0.2 wt % to 5 wt %, 0.3 wt % to 3 wt %, 0.5 wt % to 2 wt %, or 0.5 wt % to 1.5 wt %, of the total weight of the solid electrolyte layer 30.

[Negative Electrode Layer]

[Negative Electrode Layer: Negative Active Material]

Referring to FIG. 7, the negative electrode layer 20 includes the negative current collector 21 and the first negative active material layer 22 on the negative current collector 21. The first negative active material layer 22 may include, for example, a negative active material and a binder.

The negative active material included in the first negative active material layer 22 may have, for example, a particle shape. The average particle diameter of the negative active material having a particle shape may be, for example, 4 μm or less, 4 μm or less, 2 μm or less, 1 μm or less, or 900 nm or less. For example, the average particle diameter of the negative active material having a particle shape may be, for example, in a range of 10 nm to 4 μm, 10 nm to 3 μm, 10 nm to 2 μm, 10 nm to 1 μm, or 10 nm to 900 nm. When the average particle diameter of the negative active material is within the ranges above, lithium may be more easily subjected to reversible absorbing and/or desorbing during charging and discharging. The average particle diameter of the negative active material may be, for example, a median diameter D50 measured by using a laser particle size distribution meter.

The negative active material included in the first negative active material layer 22 may include, for example, at least one selected from a carbon-based negative active material and a metallic or metalloid negative active material.

The carbon-based negative active material may be, in particular, amorphous carbon. The amorphous carbon may include, for example carbon black (CB), acetylene black (AB), furnace black (FB), ketjen black (KB), graphene, or the like, but is not necessarily limited thereto. Any material categorized as amorphous carbon in the art may be used. The amorphous carbon is carbon that has no or very low crystallinity, and in this regard, may be distinguished from crystalline carbon or graphite-based carbon.

The metallic or metalloid negative active material may include at least one selected from gold (Au), platinum (Pt), palladium (Pd), silicon (Si), silver (Ag), aluminum (Al), bismuth (Bi), tin (Sn), and zinc (Zn), but is not necessarily limited thereto. Any material available as a metallic negative active material or metalloid negative active material capable of forming an alloy or compound with lithium in the art may be used. For example, since nickel (Ni) does not form an alloy with lithium, Ni is not a metallic negative active material.

The first negative active material layer 22 may include one type of a negative active material from among the negative active materials described above, or a mixture of a plurality of different negative active materials. For example, the first negative active material layer 22 may include only amorphous carbon, or at least one selected from the group consisting of Au, Pt, Pd, Si, Ag, Al, Bi, Sn, and Zn. Alternatively, the first negative active material layer 22 may include a mixture of amorphous carbon with at least one selected from the group consisting of Au, Pt, Pd, Si, Ag, Al, Bi, Sn, and Zn. Here, the mixing ratio of the amorphous carbon to Au or the like in the mixture may be, for example, in a range of 10:1 to 1:2, 5:1 to 1:1, or 4:1 to 2:1, but is not necessarily limited thereto. The mixing ratio may be determined depending on the characteristics of the required all-solid-state secondary battery. When the negative active material has such a composition, the cycle characteristics of the all-solid-state secondary battery may be further improved.

The negative active material included in the first negative active material layer 22 may include, for example, a mixture of first particles consisting of amorphous carbon and second particles consisting of metal or metalloid. The metal or metalloid may include, for example, Au, Pt, Pd, Si, Ag, Al, Bi, Sn, Zn, and the like. The metalloid may be, in other words, a semiconductor. The amount of the second particle may be in a range of 8 wt % to 60 wt %, 10 wt % to 50 wt %, 15 wt % to 40 wt %, or 20 wt % to 30 wt %, based on the total weight of the mixture. When the amount of the second particle is within the ranges above, the cycle characteristics of the all-solid-state secondary battery may be further improved.

[Negative Electrode Layer: Binder]

The binder included in the first negative active material layer 22 may include, for example, SBR, PTFE, PVDF, polyethylene, vinylidene fluoride/hexafluoropropylene copolymer, polyacrylonitrile, polymethyl methacrylate, or the like, but is not necessarily limited thereto. Any material available as a binder in the art may be used. The binder may be used alone, or may be used with multiple binders that are different from each other.

When the first negative active material layer 22 includes the binder, the first negative active material layer 22 may be stabilized on the negative current collector 21. In addition, despite a change in volume and/or relative position of the first negative active material layer 22, cracking of the first negative active material layer 22 may be suppressed. For example, when the first negative active material layer 22 does not include a binder, the first negative active material layer 22 may be easily separated from the negative current collector 21. At a portion where the negative current collector 21 is exposed by the separation of the first negative active material layer 22 from the negative current collector 22, the possibility of occurrence of a short circuit may increase as the negative current collector 21 is in contact with the electrolyte layer 30. The first negative active material layer 22 may be prepared by, for example, coating the negative current collector 21 with a slurry in which a material constituting the first negative active material layer 22 is dispersed, and drying the coating. The inclusion of the binder in the first negative active material layer 22 may enable to stably disperse the negative active material in the slurry. For example, when the negative current collector 21 is coated with the slurry by a screen printing method, clogging of the screen (for example, clogging by an agglomerate of the negative electrode active material) may be suppressed.

[Negative Electrode Layer: Other Additives]

The first negative active material layer 22 may further include additives, for example, a filler, a coating agent, a dispersant, an ionic conductive auxiliary agent, or the like, as used in the all-solid-state secondary battery 1 in the art.

[Negative Electrode Layer: First Negative Active Material]

The thickness of the first negative active material layer 22 may be, for example, 50% or less, 40% or less, 30% or less, about 20% or less, 10% or less, or 5% or less, of the thickness of the positive active material layer 12. The thickness of the first negative active material layer 22 may be, for example, in a range of 1 μm to 20 um, 2 μm to 10 um, or 3 um to 7 μm. When the first negative active material layer 22 is too thin, lithium dendrites formed between the first negative active material layer 22 and the negative current collector 21 may collapse the first negative active material layer 22, and thus the cycle characteristics of the all-solid-state secondary battery 1 may be difficult to improve. When the first negative active material layer 22 is too thick, the energy density of the all-solid-state secondary battery 1 may be lowered and the internal resistance of the all-solid-state secondary battery 1 by the first negative active material layer 22 may increase, and thus the cycle characteristics of the all-solid-state secondary battery 1 may be difficult to improve.

When the thickness of the first negative active material layer 22 is reduced, for example, the charging capacity of the first negative active material layer 22 may be also reduced. The charging capacity of the first negative active material layer 22 may be, for example, 50% or less, 40% or less, 30% or less, 20% or less, 10% or less, or 5% or less, than the charging capacity of the positive active material layer 12. The charging capacity of the first negative active material layer 22 may be, for example, 0.1% to 50%, 0.1% to 40%, 0.1% to 30%, 0.1% to 20%, 0.1% to 10%, 0.1% to 5%, or 0.1% to 2%, with respect to the charging capacity of the positive active material layer 12. When the charging capacity of the first negative active material layer 22 is significantly small, the first negative active material layer 22 becomes very thin. In this regard, lithium dendrites formed between the first negative active material layer 22 and the negative current collector 21 during a repeated process of charging and discharging may collapse the first negative active material layer 22, and thus the cycle characteristics of the all-solid-state secondary battery 1 may be difficult to improve. When the charging capacity of the first negative active material layer 22 excessively increases, the energy density of the all-solid-state secondary battery 1 may be lowered and the internal resistance of the all-solid-state secondary battery 1 by the first negative active material layer 22 may increase, and thus the cycle characteristics of the all-solid-state secondary battery 1 may be difficult to improve.

The charging capacity of the positive active material layer 12 may be obtained by multiplying the charging capacity density (mAh/g) of the positive active material by the mass of the positive active material in the positive active material layer 12. When several types of the positive active material are used, for each positive active material, the charging capacity density is multiplied by the mass, and the sum of these values is the charging capacity of the positive active material layer 12. The charging capacity of the first negative active material layer 22 may be calculated in the same way. That is, the charging capacity of the first negative electrode material layer 22 may be obtained by multiplying the charging capacity density (mAh/g) of the negative active material by the mass of the negative active material in first negative active material layer 22. When several types of the negative active material are used, for each negative active material, the charging capacity density is multiplied by the mass, and the sum of these values is the charging capacity of the first negative active material layer 22. Here, the charge capacity densities of the positive active material and the negative active material are capacities estimated by using an all-solid half-cell using lithium metal as a counter electrode. The charging capacities of the positive active material layer 12 and the first negative active material layer 22 may be directly measured by measuring the charging capacity obtained by using the all-solid half-cell. When the measured charge capacity is divided by the mass of each active material, the charge capacity density is obtained. Alternatively, the charging capacities of the positive active material layer 12 and the first negative active material layer 22 may be initial charging capacities measured during the first cycle of charging.

[Negative Electrode Layer: Second Negative Active Material (Precipitation Layer)]

The all-solid-state secondary battery 1 may further include, for example, a second negative active material layer (not shown) arranged between the negative current collector 21 and the first negative active material layer 22 by charging. The second negative active material layer may be a metal layer including Li or a Li alloy. The metal layer may include Li or a Li alloy. Therefore, the second negative active material layer, which is a Li-including metal layer, may serve as, for example, a Li reservoir. The Li alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, but is not limited thereto. Any material alloyable with Li in the art may be used. The second negative active material layer may consist of Li, one of the alloys above, or several kinds of alloys.

The thickness of the second negative active material layer is not particularly limited, but may be, for example, in a range of 1 um to 1,000 um, 1 um to 500 um, 1 um to 200 um, 1 um to 150 um, 1 um to 100 um, or 1 um to 50 um. When the second negative active material layer is significantly thin, the second negative active material layer may have a difficulty in performing a function as a Li reservoir. On the other hand, when the second negative active material layer is significantly thick, the mass and volume of the all-solid-state secondary battery 1 may increase and the cycle characteristics of the all-solid-state secondary battery 1 may be rather degraded. The second negative active material layer may be, for example, a metal foil having a thickness within the ranges above.

In the all-solid-state secondary battery 1, the second negative active material layer may be, for example, precipitated between the negative current collector 21 and the first negative active material layer 22 by charging after assembling the all-solid-state secondary battery 1. When the second negative active material layer is precipitated by charging after assembling the all-solid-state secondary battery 1, the second negative active material layer is not included at the time of the assembly of the all-solid-state secondary battery 1, and thus the energy density of the all-solid-state secondary battery 1 may increase. For example, during charging of the all-solid-state secondary battery 1, the all-solid-state secondary battery 1 may be charged in excess of the charging capacity of the first negative active material layer 22. That is, the first negative active material layer 22 may be overcharged. At the beginning of charging, Li may be occluded into the first negative active material layer 22. The negative active material included in the first negative active material layer 22 may form an alloy or compound with Li ions that have transported from the positive electrode layer 10. When the charging is performed at a capacity beyond the capacity of the first negative active material layer 22, for example, Li may be precipitated on a rear surface of the first negative active material layer 22, i.e., a surface between the negative current collector 21 and the first negative active material layer 22. By precipitated Li, a metal layer corresponding to the second negative active material layer may be formed. In this regard, the second negative active material layer is a metal layer mainly consisting of Li (i.e., metallic Li). Such a result may be obtained, for example, when the negative active material included in the first negative active material layer 22 consists of a material that forms an alloy or compound with Li. At the time of discharging, Li included in the first negative active material layer 22 and the second negative active material layer, which is a metal layer, may be ionized and move toward the positive electrode layer 10. In this regard, Li may be used as the negative active material in the all-solid-state secondary battery 1. In addition, since the first negative active material layer 22 covers the second negative active material layer, the first negative active material layer 22 may serve as a protective layer for the second negative active material layer which is a metal layer, and at the same time, may serve as a layer suppressing the precipitation growth of Li dendrite. Therefore, the short circuit and the capacity degradation of the all-solid-state secondary battery 1 may be suppressed, and consequently, the cycle characteristics of the all-solid-state secondary battery 1 may be improved. In addition, when the second active material layer is arranged by charging after the assembly of the all-solid-state secondary battery 1, the negative current collector 21, the first negative active material layer 22, and a region therebetween may be, for example, Li-free regions that do not include Li in an initial state or a post-discharge state of the all-solid-state secondary battery 1.

[Negative Electrode Layer: Negative Current Collector]

The negative current collector 21 may be formed of, for example, a material that does not react with Li, that is, a material that forms neither an alloy nor a compound with Li. A material for forming the negative current collector 21 may be, for example, copper (Cu), stainless steel, titanium (Ti), iron (Fe), cobalt (Co), nickel (Ni), and the like, but is not limited thereto. Any material available as an electrode current collector in the art may be used. The negative current collector 21 may be formed of one of the above-described metals, an alloy of two or more of the above0described metals, or a coating material. The negative current collector 21 may be, for example, in the form of a plate or foil. The thickness of the negative current collector 11 may be, for example, in a range of 5 um to 100 um, 5 um to 50 um, 5 um to 40 um, 5 um to 30 um, or 10 um to 20 um.

The all-solid-state secondary battery 1 may further include, for example, a thin film, which includes an element capable of forming an alloy with Li, on the negative current collector 21. The thin film may be arranged between the negative current collector 21 and the first negative active material layer 22. The thin film may include, for example, an element capable of forming an alloy with Li. The element capable of forming an alloy with lithium may include, for example, gold, silver, zinc, tin, indium, silicon, aluminum, bismuth, and the like, but is not necessarily limited thereto. Any material available as an element capable of forming an alloy with lithium in the art may be used. The thin film may be formed of one of these metals or an alloy of several types of metals. By arranging thin film on the negative current collector 21, for example, a precipitation shape of the second negative active material layer precipitated between the thin film and the first negative active material layer 22 may be further flattened, and accordingly, the cycle characteristics of the all-solid-state secondary battery 1 may be further improved.

The thickness of the thin film may be, for example, in a range of 1 nm to 800 nm, 10 nm to 700 nm, 50 nm to 600 nm, or 100 nm to 500 nm. When the thickness of the thin film is less than 1 nm, the thin film may have a difficulty in exhibiting a function thereof. When the thin film is too thick, the thin film itself may adsorb Li so that an amount of Li precipitated in the negative electrode may be decreased, and accordingly, the energy density and the cycle characteristics of the all-solid-state secondary battery 1 may be degraded. The thin film may be disposed on the negative current collector 21 by, for example, a vacuum deposition method, a sputtering method, a plating method, or the like, but is not necessarily limited thereto, Any method capable of forming a thin film in the art may be used.

### MODE FOR INVENTION

Hereinafter, the present creative idea will be described in more detail through Examples and Comparative Examples below. However, these examples are provided to represent the creative idea, and the scope of the present creative idea is not limited thereto.

### Example 1: LZO-Coated NCM (Ni 89.6%), 18 um/3 um Bimodal

(Preparation of Positive Electrode Layer)

For use as a first positive active material and a second positive active material, respectively, Li₂O—ZrO₂ (LZO)-coated LiNi_{0.896}Co_{0.072}Mn_{0.031}O₂ (NCM) was prepared. A positive active material coated with Li₂O—ZrO (LZO) was prepared according to the method disclosed in KR 10-2014-0074174. An LZO coating layer was arranged on an NCM core. The average particle diameter D50 of the first positive active material was 18 um, and the average particle diameter D50 of the second positive active material was 3 um. The weight ratio of the first positive active material and the second positive active material was 80:20. The amount of the Li₂O—ZrO (LZO) coating layer was 0.5 mol %.

For use as a solid electrolyte, a mixture of Li₂S—P₂S₅—LiCl and Li₂S—P₂S₅—LiCl—LiBr mixed at a weight ratio of 1:1 was prepared. For use as a binder, a polytetrafluoroethylene (PTFE) binder (e.g., Teflon binder by DuPont Corporation) was prepared. For use as a conductive material, a mixture of carbon nanofiber (CNF) and carbon black (CB) mixed at a weight ratio of 1:1 was prepared. These materials, i.e., the first positive active material layer, the second positive active material layer, the solid electrolyte, the conductive material, and the binder, were mixed at a weight ratio of 71.2:17.8:9:1:1 to form a first positive active material layer composition which was then molded into a sheet shape. By vacuum drying at 40° C. for 8 hours, a positive electrode active material sheet including the active material layer was prepared. The positive electrode sheet was compressed on one surface of a positive current collector consisting of a carbon-coated aluminum foil having a thickness of 18 μm to prepare a positive electrode layer. Here, the thickness of the positive active material layer included in the positive electrode was about 100 um.

(Preparation of Solid Electrolyte Layer)

For use as a solid electrolyte, a mixture of Li₂S—P₂S₅—LiCl and Li₂S—P₂S₅—LiCl—LiBr mixed at a weight ratio of 1:1 was prepared. For use as a binder, a PTFE binder (e.g., Teflon binder by DuPont Corporation) was prepared. These materials, i.e., the solid electrolyte and the binder, were mixed at a weight ratio of 98.5:1.5 to prepare a mixture. The mixture thus prepared was stirred while adding xylene thereto to prepare a slurry. The slurry thus prepared was then applied onto a non-woven fabric by using a bar coater, and dried in the air at 80° C. for 10 minutes to obtain a laminate. The laminate thus obtained was dried in vacuum at 80° C. for 10 hours. As such, a solid electrolyte layer was prepared by the process described above.

(Preparation of Negative Electrode Layer)

For use as a negative current collector, a Ni foil having a thickness of 10 μm was prepared. Also, CB having a primary particle diameter of about 30 nm and Ag particles having an average particle diameter of about 60 nm were prepared for use as a negative active material.

4 g of mixed powder obtained by mixing the CB particles and the Ag particles at a weight ratio of 3:1 was put into a container, and 4 g of an NMP solution containing 7 wt % of a PVDF binder (#9300 of KUREHA CORPORATION) was added thereto to prepare a mixed solution. Then, a slurry was prepared by stirring the mixed solution while adding NMP little by little to the mixed solution. The slurry thus obtained was applied onto an SUS sheet by using a bar coater, and the SUS sheet was dried in the air at 80° C. for 10 minutes to prepare a laminate. The laminate thus obtained was then dried in vacuum at 40° C. for 10 hours. The dried laminate was roll-pressed at a pressure of 3001 Pa for 10 ms to flatten the surface of a first negative active material layer of the laminate. As such, a negative electrode layer was prepared by the above-described processes. Here, the thickness of the first negative active material layer included in the negative electrode layer was about 7 mm.

(Preparation of all-Solid-State Secondary Battery)

The solid electrolyte layer was arranged on one surface of the negative electrode layer, and the positive electrode layer was arranged on the solid electrolyte layer to prepare a laminate. The laminate thus prepared was the housed in a pouch and sealed. The sealed laminate was treated with a warm isotactic press (WIP) at 80° C. at a pressure of 490 MPa for 30 minutes. Here, the thickness of the pressed solid electrolyte layer was about 30 um. In addition, by the pressure treatment, one or more cracks radially arranged inside the secondary particles of the first positive active material were formed.

### Example 2: LZO-Coated NCA (Ni 88.0%), 18 um/3 um Bimodal

A positive electrode and an all-solid-state secondary battery were prepared in the same manner as in Example 1, except that, for use as a first positive active material and a second positive active material, Li₂O—ZrO₂ (LZO)-coated LiNi_{0.88}Co_{0.105}Al_{0.015}O₂ (NCA) was used instead of the Li₂O—ZrO₂ (LZO)-coated LiNi_{0.896}Co_{0.072}Mn_{0.031}O₂ (NCM).

### Example 3: LZO-Coated NCA (Ni 91.7%), 18 um/3 um Bimodal

A positive electrode and an all-solid-state secondary battery were prepared in the same manner ras in Example 1, except that, for use as a first positive active material and a second positive active material, Li₂O—ZrO₂ (LZO)-coated LiNi_{0.917}Co_{0.069}Al_{0.014}O₂ (NCA) was used instead of the Li₂O—ZrO₂ (LZO)-coated LiNi_{0.896}Co_{0.072}Mn_{0.031}O₂ (NCM).

### Example 4: LZO/Co-Rich-Coated NCM (Ni 89.6%), 18 um/3 um Bimodal

A positive electrode and an all-solid-state secondary battery were prepared in the same manner ras in Example 1, except that, for use as a first positive active material and a second positive active material, LiNi_{0.917}Co_{0.069}Mn_{0.014}O₂ (NCM) sequentially coated with Co-rich NCM and Li₂O—ZrO₂ (LZO) was used, instead of the Li₂O—ZrO₂ (LZO)-coated LiNi_{0.896}Co_{0.072}Mn_{0.031}O₂ (NCM). The Co-rich NCM coating layer and the LZO coating layer were sequentially arranged on the NCM core.

Based on 100 parts by weight of the positive active material powder, LiNi_{0.917}Co_{0.069}Mn_{0.014}O₂ (NCM), 0.25 parts by weight of Co₃O₄ as a Co precursor was mixed and 100 parts by weight of distilled water was added thereto to prepare a mixed solution.

The mixed solution was dried in an oven at 150° C. for 15 hours while stirring to obtain a dried product having a Co precursor supported on the surface. The dried product was put into a furnace and heat-treated at 720° C. for 5 hours while flowing oxygen thereinto to prepare a composite positive active material including the Co-rich NCM coating layer formed thereon. Here, the amount of the Co-rich NCM coating layer was 0.25 wt %. Subsequently, an LZO coating layer was introduced in the same manner as in Example 1. Here, the amount of the Li₂O—ZrO (LZO) coating layer was 0.5 mol %.

### Example 5: LZO/Co-Rich NCA-Coated NCA (Ni 88%), 18 um/3 um Bimodal

A positive electrode and an all-solid-state secondary battery were prepared in the same manner ras in Example 1, except that, for use as a first positive active material and a second positive active material, LiNi_{0.88}Co_{0.0105}Al_{0.015}O₂ (NCA) sequentially coated with Co-rich NCA and Li₂O—ZrO₂ (LZO) was used, instead of the Li₂O—ZrO₂ (LZO)-coated LiNi_{0.896}Co_{0.072}Mn_{0.031}O₂ (NCM). The Co-rich NCA coating layer and the LZO coating layer were sequentially arranged on the NCA core.

The Co-rich NCA coating layer and the LZO coating layer were arranged in the same manner as in Example 4. Here, the amount of the Co-rich NCA coating layer was 0.25 wt %. The amount of the Li₂O—ZrO (LZO) coating layer was 0.5 mol %.

### Example 6: LZO/Co-Rich NCM-Coated NCA (Ni 91.7%), 18 um/3 um Bimodal

A positive electrode and an all-solid-state secondary battery were prepared in the same manner ras in Example 1, except that, for use as a first positive active material and a second positive active material, LiNi_{0.917}Co_{0.069}Al_{0.014}O₂ (NCA) sequentially coated with Co-rich NCA and Li₂O—ZrO₂ (LZO) was used, instead of the Li₂O—ZrO₂ (LZO)-coated LiNi_{0.896}Co_{0.072}Mn_{0.031}O₂ (NCM). The Co-rich NCA coating layer and the LZO coating layer were sequentially arranged on the NCM core.

The Co-rich NCA coating layer and the LZO coating layer were arranged in the same manner as in Example 4. Here, the amount of the Co-rich NCA coating layer was 0.25 wt %. The amount of the Li₂O—ZrO (LZO) coating layer was 0.5 mol %.

### Example 7: Bare NCA (Ni 88.0%), 18 um/3 um Bimodal

A positive electrode and an all-solid-state secondary battery were prepared in the same manner ras in Example 1, except that, for use as a first positive active material and a second positive active material, bare LiNi_{0.88}Co_{0.105}Al_{0.015}O₂ (NCA) that is free of the LZO coating layer was used instead of the Li₂O—ZrO₂ (LZO)-coated bare LiNi_{0.896}Co_{0.072}Mn_{0.031}O₂ (NCM).

### Comparative Example 1: LZO-Coated NCM (Ni 89.6%), 6 um Monomodal

A positive electrode and an all-solid-state secondary battery were prepared in the same manner as in Example 1, except that, for use as a positive active material, Li₂O—ZrO₂ (LZO)-coated LiNi_{0.896}Co_{0.072}Mn_{0.031}O₂ (NCM) having an average particle diameter D50 of 6 um was used alone.

### Comparative Example 2: LZO-Coated NCM (Ni 89.6%), 18 um/3 um Bimodal, WIP Process Omitted

A positive electrode and an all-solid-state secondary battery were prepared in the same manner as in Example 1, except that a step of WIP treatment was omitted during the preparation method of the all-solid-state secondary battery.

### Evaluation Example 1: Confirmation of Cracked State of Cross Section of Positive Active Material

Cross sections of the all-solid-state secondary batteries of Examples 1 to 7 and Comparative Examples 1 and 2 were observed with a scanning electron microscope (SEM) to observe whether cracks occurred in the secondary particles of the positive active material.

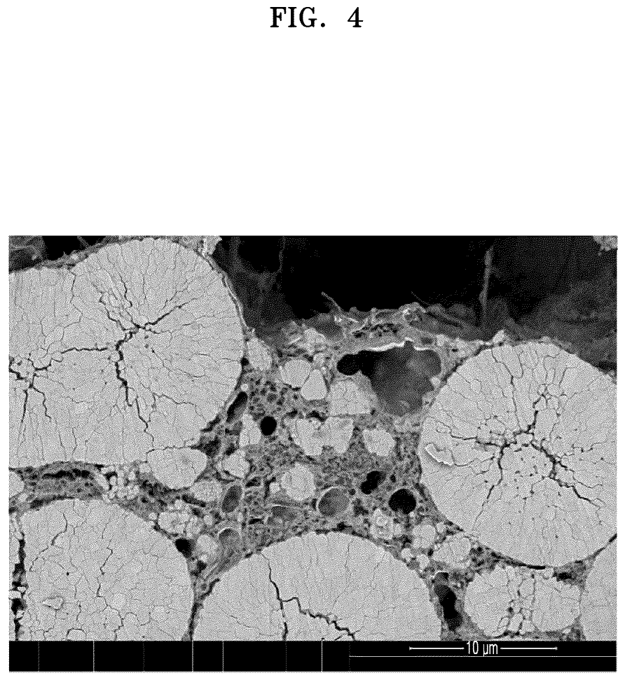

FIG. 4 is a cross-sectional SEM image of the positive active material layer of the all-solid-state secondary battery prepared in Example 1. As shown in FIG. 4, a plurality of cracks radially arranged from the center of the secondary particle were included inside the secondary particle of the first positive active material which is a large-diameter positive active material.

Therefore, the physical contact among primary particles, which constitute the secondary particle, was maintained from the surface of the secondary particle to the inside, for example, the center of the secondary particle, and thus occurrence of an electrically shorted portion inside the secondary particle was suppressed.

Here, the ratio of width to length of the crack was about 1:50 to about 1:100. The length of the crack was 30% to 80% of the diameter of the secondary particle. In some secondary particles, the cracks extended from the center of the secondary particle to the surface of the secondary particle, and thus the cracks were also exposed on the surface of the secondary particle.

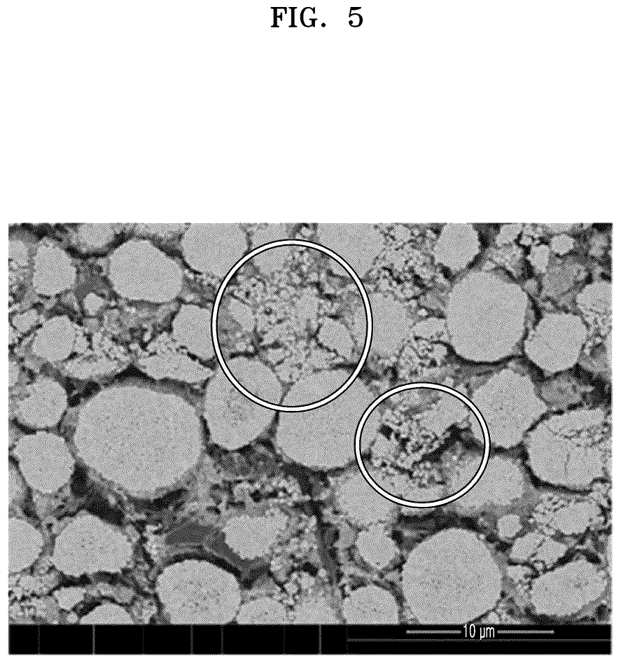

FIG. 5 is a cross-sectional SEM image of the positive active material layer of the all-solid-state secondary battery prepared in Comparative Example 1. As shown in FIG. 5, a plurality of cracks arranged without orientation were included inside the secondary particle of the positive active material. Accordingly, due to these cracks, many electrically shorted parts were generated inside the secondary particle.

FIG. 6 is a cross-sectional SEM image of the positive active material layer of the all-solid-state secondary battery prepared in Comparative Example 2. As shown in FIG. 6, the first positive active material that was not subjected to the WIP treatment did not include cracks inside the secondary particle.

### Evaluation Example 2: Comparison in Mixture Density

The mixture density of the positive active material layer included in each of the all-solid-state secondary batteries prepared in Examples 1 to 7 and Comparative Examples 1 and 2 was measured, and results thereof are shown in Table 1.

The mixture density was measured from the thickness and weight of the positive active material layer by disassembling the prepared all-solid-state secondary battery.

TABLE 1

| | Mixture density |
|---|---|
| | [g/cc] |
| Example1 | 3.42 |
| Example 2 | 3.67 |
| Example 3 | 3.62 |
| Example 4 | 3.57 |
| Example 5 | 3.52 |
| Example 6 | 3.47 |
| Example 7 | 3.45 |
| Comparative | 3.21 |
| Example 1 | |
| Comparative | 3.30 |
| Example 2 | |

As shown in Table 1, the positive active material layers included in the all-solid-state secondary batteries of Examples 1 to 7 had improved mixture density compared to the positive active material layers included in the all-solid-state secondary batteries of Comparative Examples 1 and 2.

Accordingly, the all-solid-state secondary batteries of Examples 1 to 7 provided improved energy density compared to the all-solid-state secondary batteries of Comparative Examples 1 and 2.

The mixture density of the positive active material layer was determined to improve, since small-diameter positive active materials were arranged among large-diameter positive active materials in the positive active material layers included in the all-solid-state secondary batteries of Examples 1 to 7.

When preparing the positive active material layer included in the all-solid-state secondary battery of Comparative Example 2, the WIP process treatment was omitted, and thus the mixture density thereof was lower than the mixture density of the positive active material layers included in the all-solid-state secondary batteries of Examples 1 to 7.

### Evaluation Example 3: Charge/Discharge Test

The charge and discharge characteristics of the all-solid-state secondary batteries of Examples 1 to 7 and Comparative Examples 1 and 2 were evaluated by the following charge/discharge test. The charge/discharge test was performed by putting the all-solid-state secondary battery in a thermostatic bath at 60° C.

In a first cycle, charging was performed with a constant current of 0.6 mA/cm² until a battery voltage reached 4.25 V, followed by charging with a constant voltage for 12.5 hours until a charging current reached 0.3 mA/cm². After a rest period of 10 minutes, discharging was performed with a constant current of 0.6 mA/cm² for 12.5 hours until the battery voltage reached 2.5 V.

In a second cycle, charging was performed with a constant current of 2.0 mA/cm² until the battery voltage reached 4.25 V, followed by charging for 4 hours until the current voltage reached 0.3 mA/cm². After a rest period of 10 minutes, discharging was performed with a constant current of 2.0 mA/cm² for 4 hours until the battery voltage reached 2.5 V.

Under the same condition as the second cycle, third to hundred cycles were performed.

The lifespan characteristics are shown in Table 2. In Table 2, the capacity retention was represented by Equation 1:

Capacity retention (%)=(discharge capacity in 1^{st} cycle/discharge capacity in 100^{th} cycle)×100 Equation 1

TABLE 2

| | Capacity retention |
|---|---|
| | [%] |
| Example 1 | 96.5 |
| Example 2 | 96.4 |
| Example 3 | 96.3 |
| Example 4 | 96.4 |
| Example 5 | 96.2 |
| Example 6 | 95.5 |
| Example 7 | 95.0 |
| Comparative | 90.0 |
| Example 1 | |
| Comparative | 89.0 |
| Example 2 | |

As shown in Table 2, the all-solid-state secondary batteries of Examples 1 to 7 had improved lifespan characteristics compared to those of the all-solid-state secondary batteries of Comparative Examples 1 and 2.

In the all-solid-state secondary batteries of Examples 1 to 7, due to the inclusion of the radially arranged cracks, the formation of an electrically shorted part inside the positive active material was suppressed.

Meanwhile, in the all-solid-state secondary battery of Comparative Example 1, due to the inclusion of the cracks without orientation, the formation of an electrically shorted part inside the positive active material was increased. Thus, it was confirmed that the increase in capacity loss was due to an increase in a portion of the positive active material not in contact with the solid electrolyte.

In the case of the all-solid-state secondary battery of Comparative Example 2, it was confirmed that, since the contact between the positive active material the included in the positive active material layer and the solid electrolyte was relatively poor, the internal resistance increased so that the all-solid-state secondary battery had poor lifespan characteristics.

After the charging of the first cycle was completed in the all-solid-state secondary batteries of Examples 1 to 7, the cross sections of these batteries were measured from the SEM images thereof to confirm the formation of a lithium metal layer, which corresponds to the second negative active material layer, between the first negative active material layer and the negative current collector.

Although exemplary embodiments have been described in detail with reference to the accompanying drawings, the present inventive concept is not limited to these examples. It is obvious that those skilled in the art to which the present creative idea belongs can derive various examples of changes or modifications within the scope of the technical idea described in the claims, and these, of course, belong to the technical scope of the present creative idea.

### ELEMENTS OF THE DRAWINGS

| | |
|---|---|
| 1: All-solid-state secondary battery | 10: Positive electrode layer |
| 11: Positive current collector | 12: Positive active material layer |
| 13: First positive active material | 14: Second positive active material |
| 15: Crack | 16: Positive active material in the art |
| 20: Negative electrode layer | 21: Negative current collector |
| 22: First negative active material | 23: Second negative active material |
| layer | layer |
| 30: Solid electrolyte layer | |

### INDUSTRIAL APPLICABILITY

An all-solid-state secondary battery including a positive electrode may have improved energy density and improved cycle characteristics.

1. A positive electrode for an all-solid battery, comprising:
a positive current collector; and
a positive active material layer arranged on the positive current collector, the positive active material layer including:
a first positive active material;
a second positive active material; and
a solid electrolyte,
wherein:
the first positive active material is a large-diameter positive active material,
the second positive active material is a small-diameter positive active material, and
the first positive active material includes a secondary particle having a plurality of primary particles, and one or more cracks are radially arranged inside the secondary particle.

2. The positive electrode of claim 1, wherein a ratio of a width to a length of the one or more cracks is in a range of about 1:10 to about 1:1000, the length of the one or more cracks is 30% or more of a diameter of the secondary particle, and the one or more cracks extend to a surface of the secondary particle.

3. The positive electrode of claim 1, wherein a width of the one or more cracks inside the secondary particle is greater than or equal to a width of the one or more cracks at a surface of the secondary particle, and the one or more cracks are connected to each other inside the secondary particle.

4. The positive electrode of claim 1, wherein a particle diameter of the first positive active material is in a range of about 11 um to about 30 um, and a particle diameter of the second positive active material is in a range of about 1 um to about 9 um.

5. The positive electrode of claim 1, wherein a weight ratio of the first positive active material to the second positive active material is in a range of about 90:10 to about 60:40.

6. The positive electrode of claim 1, wherein at least one of the first positive active material and the second positive active material includes a nickel-based first lithium transition metal oxide represented by Formula 1:
LiₐNi_{b}M1_{c}M2_{d}M3ₑO_{2-α}X_{α} Formula 1
wherein, in the formulae above,
0.9≤a≤1.1, 0.7<b<1.0, 0<c<0.3, 0<d<0.3, 0≤e<0.1, b+c+d+e=1, and 0≤α<2,
M1, M2, and M3 are each one selected from cobalt (Co), manganese (Mn), zirconium (Zr), aluminum (Al), rhenium (Re), vanadium (V), chrome (Cr), iron (Fe), boron (B), ruthenium (Ru), titanium (Ti), niobium (Nb), molybdenum (Mo), magnesium (Mg), and platinum (Pt), and
X is an element selected from oxygen (O), fluorine (F), sulfur (S), and phosphorus (P).

7. The positive electrode of claim 6, wherein the nickel-based first lithium transition metal oxide represented by Formula 1 is represented by one of Formulae 2 and 3:
LiₐNi_{b}Co_{c}Mn_{d}M4ₑO_{2-α}X_{α} Formula 2
LiₐNi_{b}Co_{c}Al_{d}M4ₑO_{2-α}X_{α} Formula 3
wherein, in the formulae above,
0.9≤a≤1.1, 0.8<b<1.0, 0<c<0.2, 0<d<0.1, 0≤e<0.01, b+c+d+e=1, and 0≤α<2,
M4 is one selected from Zr, Al, V, Cr, Fe, Re, B, Ru, Ti, Nb, Mo, Mg, and Pt, and
X is an element selected from O, F, S, and P.

8. The positive electrode of claim 6, wherein:
the first positive active material includes a core and a first coating layer arranged on the core,
the core includes the nickel-based first lithium transition metal oxide, and
the first coating layer includes an oxide ionic conductor.

9. The positive electrode of claim 8, wherein the oxide ionic conductor includes Li₂O—ZrO₂.

10. The positive electrode of claim 8, further comprising a second coating layer arranged between the core and the first coating layer,
wherein the second coating layer includes a nickel-based second lithium transition metal oxide having a greater Co amount than that of the nickel-based first lithium transition metal oxide.

11. The positive electrode of claim 10, wherein the second lithium transition metal oxide is represented by one of Formulae 4 and 5:
LiₐNiₚCo_{q}MnᵣM5ₛO_{2-α}X_{α} Formula 4
LiₐNiₚCo_{q}AlᵣM5ₛO_{2-α}X_{α} Formula 5
wherein, in the formulae above,
0.9≤a≤1.1, 0.4≤p≤08, 0.3≤q≤0.6, 0<r<0.05, 0≤s<0.01, p+q+r+s=1, and 0≤α<2,
M4 may be one selected from Zr, Al, V, Cr, Fe, Re, B, Ru, Ti, Nb, Mo, Mg, and Pt, and
X may be an element selected from O, F, S, and P.

12. The positive electrode of claim 1, wherein the solid electrolyte is a sulfide-based solid electrolyte.

13. The positive electrode of claim 1, wherein the sulfide-based solid electrolyte includes at least one selected from Li₂S—P₂S₅, Li₂S—P₂S₅—LiX (where X is Cl, Br, F, or I), Li₂S—P₂S₅—LiCl—LiBr, Li₂S—P₂S₅—Li₂O, Li₂S—P₂S₅—Li₂O—LiI, Li₂S—SiS₂, Li₂—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, Z is one of Ge, Zn, or Ga), Li₂S—GeS₂, Li₂S—SiS₂—Li₃PO₄, Li₂S—SiS₂—LiₚMO_{q} (where p and q are each a positive number, and M is one of P, Si, Ge, B, Al, Ga, or In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

14. The positive electrode of claim 1, wherein:
the positive active material layer additionally includes a conductive material and a binder,
the conductive material includes at least one selected from a fibrous conductive material and a particulate conductive material,
the binder includes a fluorine-based binder,
the positive active material layer has a mixture density of 3.3 g/cc or more, and
the second positive active material does not include the one or more cracks that are radially arranged inside the secondary particle.

15. An all-solid-state secondary battery, comprising:
the positive electrode according claim 1;
a negative electrode; and
a solid electrolyte layer,
wherein the negative electrode includes a negative current collector; and a first negative active material layer arranged on the negative current collector.

16. The all-solid-state secondary battery of claim 15, wherein the first negative active material layer includes a negative active material and a binder, the negative active material has a particle shape, and an average particle diameter of the negative active material is 4 um or less.

17. The all-solid-state secondary battery of claim 16, wherein the negative active material includes at least one selected from a carbon-based negative active material and a metal or metalloid negative active material, and the carbon-based negative active material includes amorphous carbon.

18. The all-solid-state secondary battery of claim 17, wherein the metal or metalloid negative active material includes at least one selected from gold (Au), platinum (Pt), palladium (Pd), silicon (Si), silver (Ag), aluminum (Al), bismuth (Bi), tin (Sn), and zinc (Zn).

19. The all-solid-state secondary battery of claim 16, wherein the negative active material includes a mixture of first particles consisting of amorphous carbon and second particles consisting of metal or metalloid, and an amount of the second particles is in a range of about 8 wt % to about 60 wt % based on a total weight of the mixture.

20. The all-solid-state secondary battery of claim 15, further comprising a second negative active material layer arranged between the negative current collector and the first negative active material layer and/or between the solid electrolyte layer and the first negative active material layer, wherein the second negative active material layer is a metal layer including lithium or lithium alloy.
